(19) United States
(12) Patent Application Publication
(10) Pub. No.: US 2025/0214558 A1
(43) Pub. Date: Jul. 3, 2025

(54) VEHICLE CONTROL SYSTEM

(71) Applicant: DENSO CORPORATION, Kariya-city (JP)

(72) Inventors: Kentaro YUTANI, Nisshin-city (JP); Masanori TAKAHASHI, Nisshin-city (JP); Koshun OGAWA, Nisshin-city (JP); Ryo ISHIBASHI, Kariya-city (JP)

(21) Appl. No.: 19/083,044

(22) Filed: Mar. 18, 2025

Related U.S. Application Data
(63) Continuation of application No. PCT/JP2023/030550, filed on Aug. 24, 2023.

(30) Foreign Application Priority Data
Sep. 20, 2022 (JP) 2022-149132

(51) Int. Cl. B60W 10/119; B60K 17/02; B60K 17/04; B60K 17/356; B60K 23/08; B60W 10/04; B60W 10/08; B60W 10/18; B60W 50/02

(52) U.S. Cl. CPC B60W 10/119; B60K 17/02; B60K 17/04; B60K 17/356; B60K 23/08; B60W 10/04; B60W 10/08; B60W 10/18; B60W 50/0205; B60W 2520/10; B60W 2710/021; B60W 2710/081; B60W 2710/18

(57) ABSTRACT

A vehicle control system controls a drive of a vehicle, and includes a drive source, a clutch, a clutch actuator, and a control unit. The clutches are provided in a power transmission path from the drive source to the drive wheel and are capable of switching between connecting and disconnecting a power transmission. The clutch actuator drives the clutch. At least one meshing portion is provided between the clutch and the drive wheel in an inclined manner with respect to a rotational direction. The control unit switches the clutch from a disengaged state to an engaged state, and controls the clutch actuator so that a load greater than the load required for engaging the clutch is generated during input of a transient torque that inputs a driving force from the drive source.

### CROSS REFERENCE TO RELATED APPLICATIONS

This application is a continuation application of International Patent Application No. PCT/JP2023/030550 filed on Aug. 24, 2023, which designated the U.S. and based on and claims the benefits of priority of Japanese Patent Application No. 2022-149132 filed on Sep. 20, 2022. The entire disclosure of all of the above applications is incorporated herein by reference.

### TECHNICAL FIELD

The present disclosure relates to a vehicle control system.

### BACKGROUND

Conventionally, there has been known a vehicle control device for controlling a drive of a vehicle.

### SUMMARY

An object of the present disclosure is to provide a vehicle control system capable of appropriately controlling a drive of a vehicle.

The vehicle control system of the present disclosure controls a drive of a vehicle, and includes a drive source, a clutch, a clutch actuator, and a control unit. The clutch is provided in a power transmission path from the drive source to a drive wheel, and is capable of switching between connecting and disconnecting a power transmission. The clutch actuator drives the clutch. The control unit controls the drive of the drive source and the clutch actuator.

At least one portion that meshes in an inclined manner with respect to a rotational direction is provided between the clutch and the drive wheel. The control unit switches the clutch from a disengaged state to an engaged state, and controls the clutch actuator so that a load greater than the load required for engaging the clutch is generated during input of a transient torque that inputs a driving force from the drive source.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic diagram showing a vehicle control system according to a first embodiment;

FIG. 2 is a schematic diagram showing a clutch and a reducer according to the first embodiment;

FIG. 3 is a schematic diagram showing a clutch according to the first embodiment;

FIG. 4 is a diagram illustrating a backlash elimination method according to the first embodiment;

FIG. 5A is a diagram showing a relationship between a gear rotation angle and an output torque when backlash is not eliminated;

FIG. 5B is a diagram showing the relationship between the gear rotation angle and the output torque when the backlash is eliminated;

FIG. 6 is a flowchart illustrating a clutch control according to the first embodiment;

FIG. 7 is a schematic diagram showing a fitting portion of a drive shaft according to a second embodiment;

FIG. 8A is a schematic diagram showing a clutch and a reducer according to a third embodiment;

FIG. 8B is a schematic diagram showing clutch engagement teeth;

FIG. 9 is a schematic diagram showing a case where a reducer is a spur gear;

FIG. 10 is a flowchart illustrating a clutch control according to a fourth embodiment;

FIG. 11 is a time chart showing the clutch control according to the fourth embodiment;

FIG. 12A is a schematic diagram showing a state in which a vehicle passes over a step;

FIG. 12B is a schematic diagram showing a state in which the vehicle has passed over the step;

FIG. 13 is a flowchart illustrating a clutch control according to a fifth embodiment;

FIG. 14 is a time chart illustrating the clutch control according to the fifth embodiment; and

FIG. 15 is a flowchart illustrating an operation check process according to a sixth embodiment.

### DETAILED DESCRIPTION

In an assumable example, there has been known a vehicle control device for controlling a drive of a vehicle. For example, a dog clutch is provided as a controllable power connection/disconnection device between a second rotating machine, which is a drive source, and a reduction gear.

In the example, a location where an abnormality has occurred is identified from a rotation signal when the dog clutch is engaged and disengaged. It does not mention clutch control other than for abnormality detection and after abnormality detection. An object of the present disclosure is to provide a vehicle control system capable of appropriately controlling a drive of a vehicle.

The vehicle control system of the present disclosure controls a drive of a vehicle, and includes a drive source, a clutch, a clutch actuator, and a control unit. The clutch is provided in a power transmission path from the drive source to a drive wheel, and is capable of switching between connecting and disconnecting the power transmission. The clutch actuator drives the clutch. The control unit controls the drive of the drive source and the clutch actuator.

In a first aspect, at least one portion that meshes in an inclined manner with respect to a rotational direction is provided between the clutch and the drive wheel. The control unit switches the clutch from a disengaged state to an engaged state, and controls the clutch actuator so that a load greater than the load required for engaging the clutch is generated during input of a transient torque that inputs a driving force from the drive source.

In a second aspect, the control unit disengages the clutch when a torque fluctuation frequency of the drive source is in a resonance region of a drive shaft connected to the drive wheel. In a third aspect, the control unit determines whether the vehicle is passing over a step, and when it is determined that the vehicle passes over the step, disengages the clutch. In a fourth aspect, the clutch is disengaged while the drive wheel is not rotating, and the drive source is driven to perform the abnormality diagnosis. This makes it possible to appropriately control the drive of the vehicle by controlling the clutch.

Hereinafter, a vehicle control system according to the present disclosure will be described with reference to the drawings. In the following plural embodiments, substantially same structural configurations are designated with the same reference numerals thereby to simplify the description.

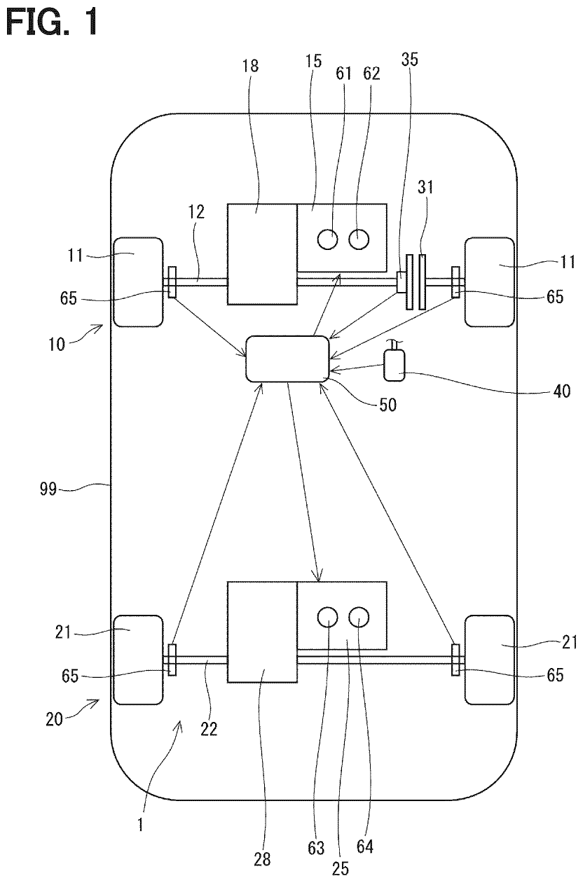

A first embodiment is shown in FIGS. 1 to 6. As shown in FIG. 1, a vehicle control device 30 is applied to a vehicle control system 1. The vehicle control system 1 includes a front wheel drive unit 10, a rear wheel drive unit 20, a clutch 31, a clutch actuator 35, a control unit 50, and the like.

The front wheel drive unit 10 includes a drive shaft 12 connected to the front wheels 11, a main motor 15, a power transmission unit 18, and the like. The rear wheel drive unit 20 includes a drive shaft 22 connected to the rear wheels 21, a main motor 25, a power transmission unit 28, and the like. The vehicle control system 1 of the present embodiment is a so-called four-wheel drive system in which the main motors 15, 25 serving as drive sources are provided on the front and rear wheels, respectively.

The main motors 15, 25 are so-called motor generators that function as an electric motor that generates torque when supplied with power from a battery (not shown), and as a generator that is driven when the vehicle 99 is braked to generate electricity. The driving force of the main motor 15 is transmitted to the drive shaft 12 via the power transmission unit 18, thereby driving the front wheels 11 to rotate. The driving force of the main motor 25 is transmitted to the drive shaft 22 via the power transmission unit 28, thereby driving the rear wheels 21 to rotate. The power transmission units 18, 28 are composed of a reducer and a differential device that absorbs the difference in rotation between the left and right wheels. Hereinafter, the front wheel drive unit 10 and the rear wheel drive unit 20 will be referred to as the “drive system” and the main motor as the “MG”.

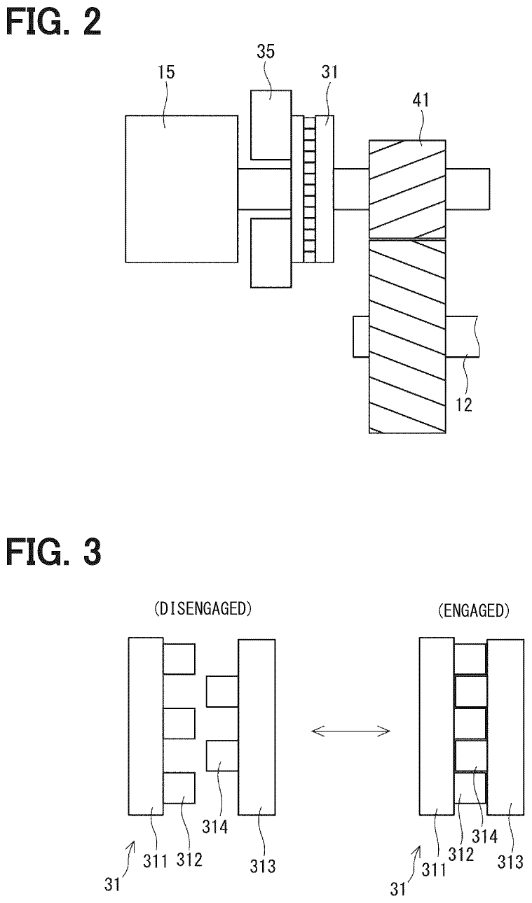

The clutch 31 is provided in the front wheel drive unit 10 and is capable of switching between connection and disconnection of the main motor 15 and the front wheels 11. The clutch 31 may be provided anywhere in the power transmission path between the main motor 15 and the front wheel 11, and in the present embodiment, it is provided between the main motor 15 and the reduction gear 41 of the power transmission unit 18 (see FIG. 2, etc.). For the sake of simplicity, FIG. 1 illustrates the clutch 31 as being provided on the drive shaft 12. The clutch actuator 35 applies a load to the clutch 31 to switch the clutch 31 between an engaged state and a disengaged state.

As shown in FIGS. 2 and 3, the clutch 31 of the present embodiment is a dog clutch and has the bases 311 and 313 and the dog teeth 312 and 314. In the present embodiment, the dog teeth 312, 314 are formed substantially perpendicular to the direction of rotation. The clutch 31 is not limited to the dog clutch, but may be a multi-plate or single-plate friction clutch.

Returning to FIG. 1, the control unit 50 is mainly composed of a microcomputer and the like, and internally includes, although not shown in the figure, a CPU, a ROM, a RAM, an I/O, a bus line for connecting these components, and the like. Each processing executed by each of the control unit 50 may be software processing or may be hardware processing. The software processing may be implemented by causing the CPU to execute a program. The program may be stored beforehand in a memory device such as a ROM, that is, in a computer-readable, non-transitory, tangible storage medium. The hardware processing may be implemented by a special purpose electronic circuit.

The control unit 50 acquires the detection values from the current sensors 61, 63 which detect the current of the main motors 15, 25, the rotation angle sensors 62, 64 which detect the rotation of the main motors 15, 25, a wheel speed sensor 65, and an accelerator opening sensor (not shown) which detects a pedal opening of the accelerator pedal 40, and controls the drive of the main motors 15, 25 and the clutch actuator 35. Although FIG. 1 illustrates the control unit 50 as being one unit, a plurality of functions may be divided into a plurality of ECUs or the like. In addition, some control lines are omitted in order to avoid complication.

Incidentally, in a mechanism that transmits power through gears, shocks occur due to collisions between the gears. Here, for example, by providing a chamfer and a spring mechanism on the teeth of the dog clutch, it is possible to reduce the engagement shock in a hardware manner. However, a configuration that reduces the engagement shock by using hardware increases the number of parts.

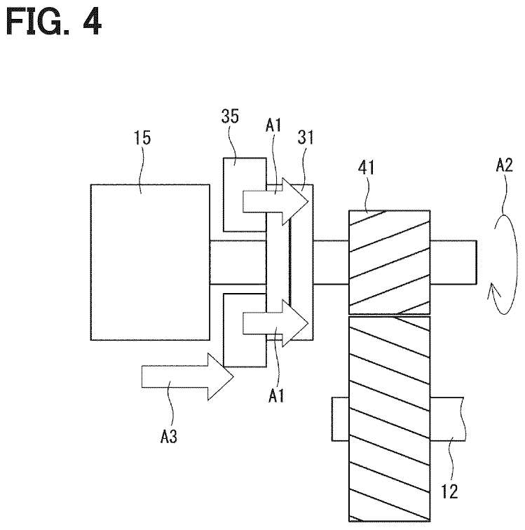

As shown in FIGS. 2 to 4, in the present embodiment, the clutch 31 is provided between the main motor 15 and the reduction gear 41. The reduction gear 41 is made up of a helical gear. When the reduction gear 41 is pushed in a thrust direction as shown by an arrow A1 in FIG. 4, the helical gear rotates as shown by an arrow A2, and the play between the gears is eliminated. Hereinafter, the total amount of play provided in the power transmission unit 18 and the like will be referred to as “backlash.”

Therefore, in the present embodiment, when a transient torque is input, the clutch 31 is used to push the reduction gear 41 in the thrust direction, thereby rotating the helical gear. This makes it possible to eliminate the backlash in the thrust and rotational directions. In addition, as shown by an arrow A3, by inputting torque from the main motor 15 when the backlash is eliminated, the rattle noise is suppressed.

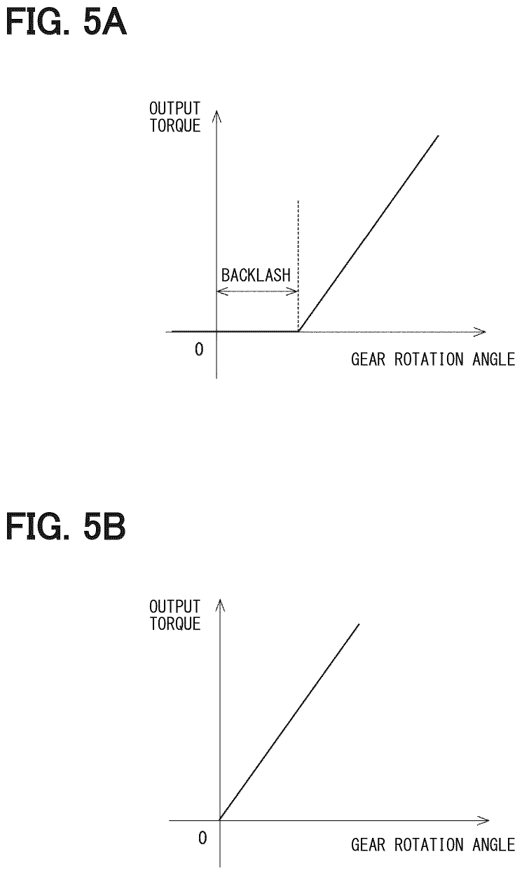

In FIGS. 5A and 5B, a horizontal axis represents the gear rotation angle on the input side of the reduction gear 41, and a vertical axis represents the torque output from the reduction gear 41. As shown in FIG. 5A, when the backlash is not eliminated on the output side of the reduction gear 41, even if the input side of the reduction gear 41 is rotating, the MG torque Tmg is not transmitted to the output side, and when the backlash is eliminated, a rattling noise is generated. The intensity of the rattle noise is approximately proportional to the amount of backlash. As shown in FIG. 5B, when the backlash is eliminated on the output side of the reduction gear 41, no rattling noise is generated, and torque is transmitted to the output shaft immediately after the main motor 15 is driven.

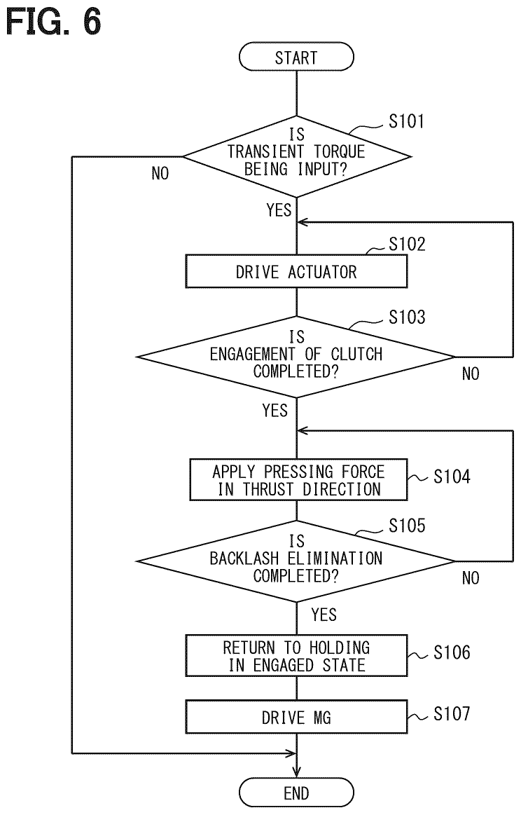

The clutch control of the present embodiment will be described with reference to the flowchart of FIG. 6. This process is carried out by the control unit 50 at a predetermined cycle. Hereinafter, “step” in step S101 is omitted, and is simply referred to as a symbol “S”.

In S101, the control unit 50 determines whether the transient torque is being input. Here, when the vehicle starts, i.e., when the main motor 15 is driven to generate MG torque from a vehicle speed of 0, when switching from coasting to driving (accelerated driving), and when switching from regeneration to driving (accelerated driving), this is regarded as a transient torque input and a positive judgment is made. When it is determined that the transient torque is not being input (S101: NO), the process from S102 onwards is skipped. When the clutch 31 is to be engaged at a time other than when the transient torque is input, the drive of the clutch actuator 35 is controlled in a process separate from this process to engage the clutch 31. When it is determined that the transient torque is being input (S101: YES), the process proceeds to S102.

In S102, the control unit 50 drives the clutch actuator 35 to engage the clutch 31. In S103, the control unit 50 determines whether or not the engagement of the clutch 31 has been completed. When it is determined that the clutch 31 has not been completely engaged (S103: NO), the process returns to S102, and the clutch actuator 35 continues to be driven. When it is determined that the engagement of the clutch 31 is completed (S103: YES), the process proceeds to S104.

In S104, the control unit 50 controls the clutch actuator 35 to apply a pressing force in the thrust direction. This eliminates the backlash in the thrust direction, and also eliminates the backlash in the rotational direction as the reduction gear 41 having helical teeth rotates (see FIG. 4).

In S105, the control unit 50 determines whether or not the elimination of the backlash has been completed. When it is determined that the backlash elimination is not completed (S105: NO), the process returns to S104, and the pressing control in the thrust direction is continued. When it is determined that the backlash elimination is completed (S105: YES), the process proceeds to S106.

In S106, the control unit 50 controls the driving of the clutch actuator 35 so as to release the pressing force in the thrust direction and to provide the pressing force capable of maintaining the clutch 31 in an engaged state. Furthermore, if a locking mechanism (not shown) for maintaining the clutch 31 in the engaged state is provided, the locking mechanism may be actuated to cut off the power supply to the clutch actuator 35.

In S107, the control unit 50 drives the main motor 15 to generate torque. At this time, since there is no backlash on the output side, the generation of rattling noise is suppressed. The process order of S106 and S107 may be interchanged so that the pushing force in the thrust direction is released after the main motor 15 starts to drive.

In the present embodiment, when the transient torque is input, the pressing force is generated in the thrust direction from the state in which the clutch 31 is engaged. Here, when the reduction gear 41 has a helical gear, the pressing force in the thrust direction is converted into a rotational force, so that backlash in the thrust direction and rotational direction can be eliminated. By eliminating the backlash before torque is generated by the main motor 15, the generation of rattling noise can be suppressed.

As described above, the vehicle control system 1 of the present embodiment controls the drive of the vehicle 99, and includes the main motor 15, the clutch 31, the clutch actuator 35, and the control unit 50. The clutch 31 is provided in the power transmission path from the main motor 15 to the front wheels 11, and is capable of switching between connecting and disconnecting the power transmission. The clutch actuator 35 drives the clutch 31. The control unit 50 controls the drive of the main motor 15 and the clutch actuator 35.

The power transmission path is provided with at least one portion where the gears mesh with each other at an angle relative to the direction of rotation. In the present embodiment, the reduction gear 41 has the helical gears, which mesh at an angle with respect to the direction of rotation. The control unit 50 switches the clutch 31 from the disengaged state to the engaged state, and controls the clutch actuator 35 so that a load greater than the load required to engage the clutch 31 is generated when a transient torque is input to input the driving force from the main motor 15.

As a result, by controlling the clutch 31, the drive of the vehicle 99 can be appropriately controlled. In detail, in the present embodiment, when a load larger than that required for engagement is generated during input of transient torque and the clutch 31 is pressed in the thrust direction, the force in the thrust direction is converted into a rotational force at the location where the clutch 31 is inclined and engaged. This makes it possible to eliminate the backlash in the thrust and rotational directions. After the backlash is eliminated, the engagement is returned to the normal state. This makes it possible to suppress the generation of rattling noise when the transient torque is input.

### Second and Third Embodiments

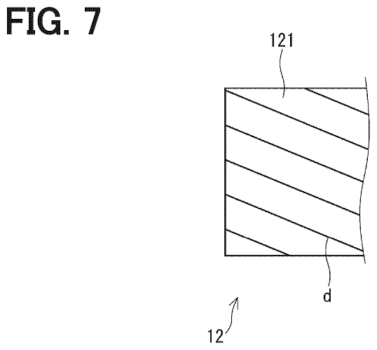

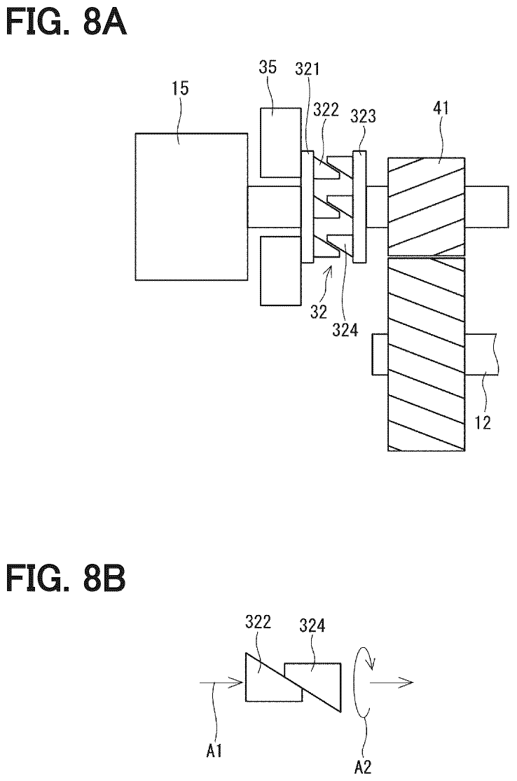

The second embodiment is shown in FIG. 7, and the third embodiment is shown in FIGS. 8A and 8B. In the second embodiment, an oblique groove d is formed in a fitting portion 121 between the clutch 31 and the drive shaft 12. In FIG. 7, the drive shaft 12 side is illustrated, and the fitting portion on the clutch 31 side is omitted.

In the third embodiment, as shown in FIG. 8A, the clutch 32 has the bases 321 and 323 and the meshing teeth 322 and 324. As shown in FIG. 8B, the meshing teeth 322, 324 are formed to be inclined with respect to the direction of rotation.

As in the second and third embodiments, by forming a portion in the power transmission path from the clutch to the reduction gear where the gears mesh obliquely with respect to the direction of rotation, it is possible to convert the thrust force by the clutch actuator 35 into a rotational force. As a result, by controlling in the same manner as in the first embodiment when the transient torque is input, it is possible to eliminate the backlash and suppress the rattling noise when torque is input from the main motor 15.

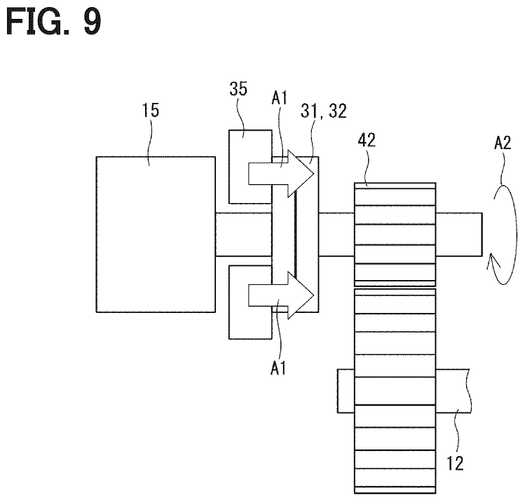

Furthermore, when an obliquely meshing structure is provided at a location other than the reduction gear as in the second or third embodiment, as shown in FIG. 9, it is possible to eliminate the backlash in the same manner as in the first embodiment even if the reduction gear 42 is a spur gear. The same effects as those of the above embodiments can be obtained even in the configuration described above.

### Fourth Embodiment

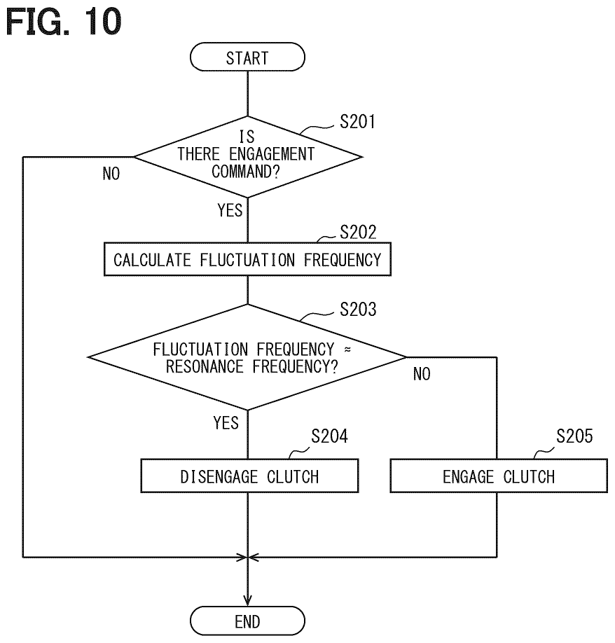

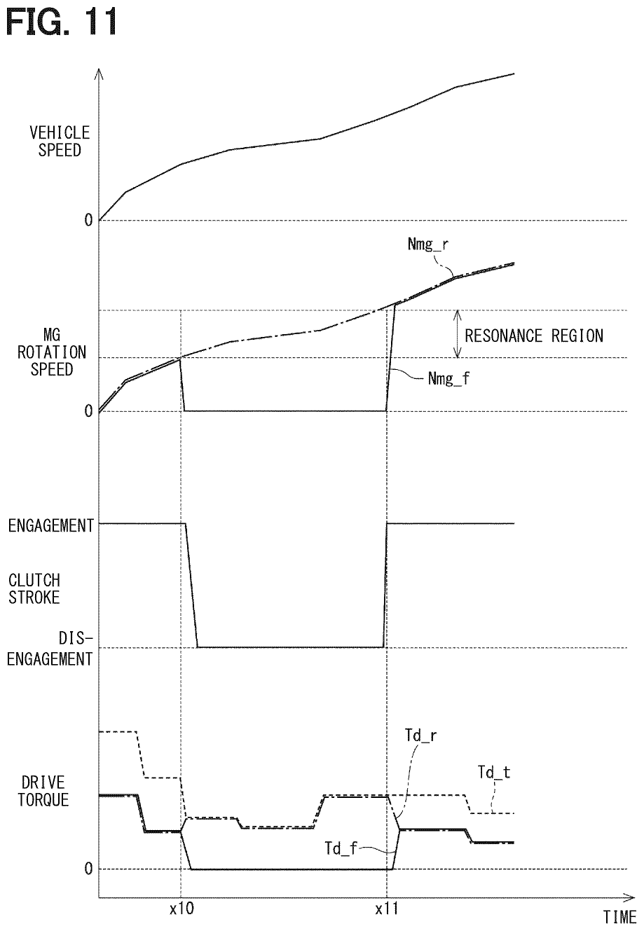

A fourth embodiment is shown in FIGS. 10 and 11. When the vehicle 99 is traveling, a resonance occurs when a fluctuation period of the cogging torque and torque ripple of the main motor 15 reaches a rotation speed corresponding to the resonance frequency of the drive system. Therefore, in the present embodiment, when the torque fluctuation frequency of the main motor 15 is in the resonance region of the drive system, the clutch 31 is disengaged and the vehicle runs using the driving force of the rear wheel drive unit 20. In other words, when the torque fluctuation frequency of the main motor 15 is in the resonance region of the drive system, the drive is switched from four-wheel drive to two-wheel drive.

The clutch control of the present embodiment will be described with reference to the flowchart of FIG. 10. In S201, the control unit 50 determines whether or not there is a command to engage the clutch 31. When it is determined that there is no command to engage the clutch 31 (S201: NO), the process from S202 onward is skipped. When it is determined that there is a command to engage the clutch 31 (S201: YES), the process proceeds to S202.

In S202, the control unit 50 calculates the torque fluctuation frequency due to torque ripple and cogging torque based on the number of poles of the main motor 15 and the MG rotation speed Nmg, etc. It is also possible to calculate a plurality of torque fluctuation frequencies, such as a fluctuation frequency due to torque ripple and a fluctuation frequency due to cogging torque.

In S203, it is determined whether the calculated torque fluctuation frequency corresponds to the resonance frequency of the drive system. Here, when the torque fluctuation frequency is within a predetermined range including the resonance frequency, a positive determination is made. Hereinafter, a predetermined range including the resonant frequency is referred to as a “resonant region.” When it is determined that the torque fluctuation frequency corresponds to the resonance frequency of the drive system (S203: YES), the process proceeds to S204. When it is determined that the torque fluctuation frequency does not correspond to the resonance frequency of the drive system (S203: NO), the process proceeds to S205.

In S204, the control unit 50 disengages the clutch 31 and set the vehicle into two-wheel drive mode using the rear wheel drive unit 20. In S205, the control unit 50 engages the clutch 31 to se the vehicle into four-wheel drive mode.

The clutch control of the present embodiment will be described with reference to a time chart of FIG. 11. In FIG. 11, the horizontal axis represents a common time axis, and from the top, a vehicle speed, a MG rotation speed, a clutch stroke, and a drive torque are shown. Here, the rotation speed of the main motor 15 on the front wheel side is indicated by Nmg_f and the drive torque is indicated by Td_f, which are indicated by solid lines, and the rotation speed of the main motor 25 on the rear wheel side is indicated by Nmg_r and the drive torque is indicated by Td_r, which are indicated by dashed lines. In this specification, the operation of the front wheel side where the clutch 31 is provided is mainly described, and the subscripts _f and _r are omitted unless it is necessary to distinguish from the rear wheel side. In FIG. 11, the front and rear wheel distribution ratio of the drive torque during four-wheel drive mode is described as 1:1, but the front and rear wheel distribution ratio may be a ratio other than 1:1.

Before time x10, the MG rotation speed Nmg is smaller than the rotation speed region where the torque fluctuation frequency corresponds to the resonance region of the front wheel drive unit 10 (hereinafter simply referred to as the “resonance region”), so the clutch 31 is engaged and the MG rotation speed Nmg is set to a rotation speed corresponding to the vehicle speed. At this time, the total torque Td_t is distributed to the main motors 15 and 25.

At time x10, when the MG rotation speed Nmg_f according to the vehicle speed enters the resonance region, the clutch 31 is disengaged and the rotation speed of the main motor 15 is set to zero. In other words, since the drive torque Td_f on the front side becomes 0, the main motor 25 is controlled so that the total torque Td_t is output from the rear wheels. By disengaging the clutch 31 between time x10 and time x11, when the torque fluctuation frequency enters the resonance region when the main motor 15 is driven, the resonance in the front wheel drive unit 10 is suppressed, so that even if the vibration occurs on the rear wheel drive unit 20 side, the total amount of vibration can be reduced. When the resonant frequency characteristics of the front wheel drive unit 10 and the rear wheel drive unit 20 are different, the resonant region of the rear wheel drive unit 20 will be different from the resonant region of the front wheel drive unit 10.

At time x11, when the MG rotation speed Nmg corresponding to the vehicle speed exceeds the resonance region, the clutch 31 is engaged and the main motor 15 is driven. Furthermore, at time x11, the transient torque is input, so the control of the first embodiment may be performed. After time x11, the total torque Td_t is distributed to the main motors 15 and 25.

As a result, by controlling the clutch 31, the drive of the vehicle 99 can be appropriately controlled. In detail, in the present embodiment, the control unit 50 disengages the clutch 31 when the torque fluctuation frequency of the main motor 15 is in the resonance region of the drive shaft 12 connected to the front wheels 11. This makes it possible to reduce vibrations of the vehicle 99.

### Fifth Embodiment

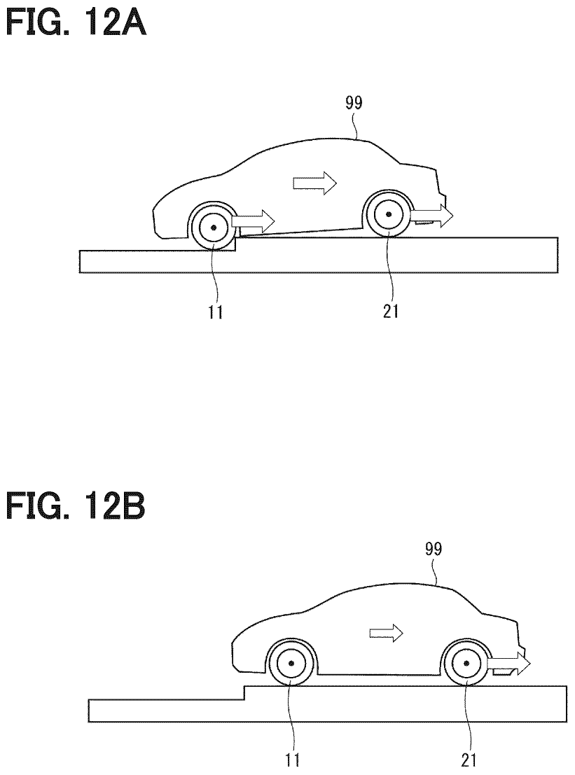

A fifth embodiment is shown in FIGS. 12A to 14. In the present embodiment, the control when passing over a step, particularly immediately after passing over the step, will be mainly described. It is not important to control the vehicle until it passes over the step.

FIGS. 12A and 12B show a schematic diagram of the vehicle 99 passing over the step, with block arrows indicating the driving forces of the front wheel drive unit 10, the rear wheel drive unit 20, and the vehicle as a whole. For example, when passing over the step in a situation where the driver's intentions are not easily reflected, such as when an electric vehicle is driving autonomously, it is necessary to suppress an excessive acceleration or the feeling of suddenly jumping out after passing over the step by reducing the MG torque Tmg after passing over the step. In the present embodiment, after the step has been passed over, the MG torque Tmg is reduced and the clutch 31 is disengaged, thereby further reducing the feeling of the vehicle jumping out after the step has been passed over.

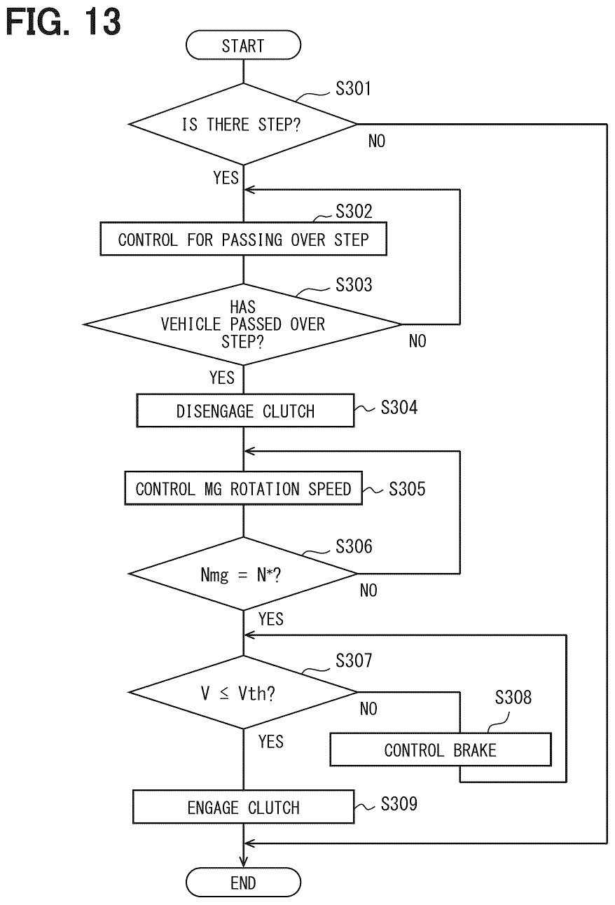

The clutch control of the present embodiment will be described with reference to the flowchart of FIG. 13. In S301, the control unit 50 determines whether or not there is a step on the travel route. When it is determined that there is no step (S301: NO), the process from S302 onwards is skipped. In S302, the drive of the main motor 15 is controlled so that the vehicle 99 can pass over the step.

In S303, the control unit 50 determines whether the vehicle 99 has passed over the step. When it is determined that the vehicle has not passed over the step (S303: NO), the process returns to S302 and the control unit 60 continues to control the vehicle so that it passes over the step. When it is determined that the vehicle has passed over the step (S303: YES), the process proceeds to S304.

The control unit 50 disengages the clutch 31 in S304, and performs the MG rotation speed control in S305. When the clutch 31 is disengaged and the load is removed, the MG rotation speed Nmg increases rapidly, so the MG rotation speed Nmg is controlled so that, for example, the MG rotation speed Nmg is controlled so that the tire rotation speed Nt corresponding to the vehicle speed when traveling with creep torque becomes a value converted into a gear ratio of the reduction gear.

In S306, the control unit 50 determines whether the MG rotation speed Nag has reached a target rotation speed Nmg*. Here, when the MG rotation speed Nag is within a predetermined range including the target rotation speed Nmg*, a positive determination is made. When it is determined that the MG rotation speed Nmg has not reached the target rotation speed Nmg* (S306: NO), the process returns to S305, and the MG rotation speed control is continued. When it is determined that the MG rotation speed Nmg has reached the target rotation speed (S306: YES), the process proceeds to S307.

In S307, the control unit 50 determines whether the vehicle speed V is equal to or less than a vehicle speed determination threshold value Vth. When it is determined that the vehicle speed V is greater than the vehicle speed determination threshold value Vth (S307: NO), the process proceeds to S308, where the brake control is performed to reduce the vehicle speed V. When it is determined that the vehicle speed V is equal to or lower than the vehicle speed determination threshold value Vth (S307: YES), the process proceeds to S309, where the clutch 31 is engaged.

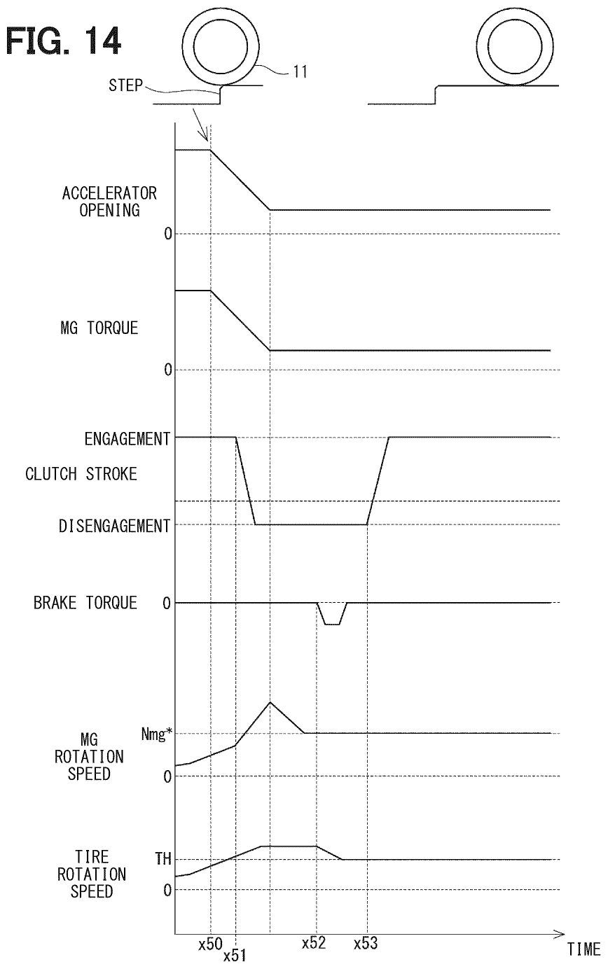

The clutch control after passing over the step will be described with reference to the time chart of FIG. 14. In FIG. 14, the horizontal axis represents a common time axis, and from the top, the accelerator opening, the MG torque, the clutch stroke, the brake torque, the MG rotation speed, and the tire rotation speed are shown.

At time x50, when the front wheels 11 pass over the step, the driver reduces the depression force, so that the accelerator opening becomes smaller and the MG torque Tmg decreases. When it is determined at time x51 that the vehicle has passed over the step, the clutch 31 is disengaged. This can reduce the feeling of jumping out after passing over the step.

When the clutch 31 is disengaged at time x51, the MG rotation speed Nmg increases, so that the MG rotation speed Nmg is controlled so as to become the target rotation speed Nmg*. Since the tire rotation speed Nt when the MG rotation speed Nmg becomes the target rotation speed Nmg* is greater than the tire rotation speed threshold TH corresponding to the vehicle speed determination threshold Vth, the brake control is performed at time x52. At time x53 after the tire rotation speed Nt reaches the tire rotation speed threshold value TH, the clutch 31 is engaged and the normal control is restored.

As a result, by controlling the clutch 31, the drive of the vehicle 99 can be appropriately controlled. In detail, in the present embodiment, the control unit 50 determines whether the front wheel 11 has passed over the step, and disengages the clutch 31 when it is determined that it has passed over the step. After the front wheel 11 has passed over the step, the clutch 31 is disengaged and the main motor 15 and the drive shaft 12 are separated, thereby suppressing sudden acceleration after the front wheel 11 has passed over the step. This further improves the vehicle stability after passing over the step.

### Sixth Embodiment

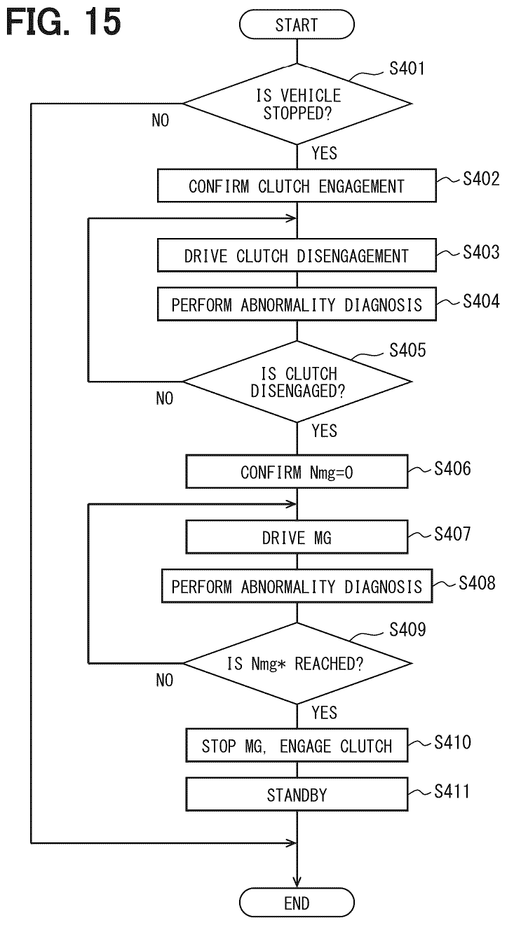

A sixth embodiment is shown in FIG. 15. In the present embodiment, the clutch 31 is disengaged to check the operation of the main motor 15 while the vehicle is stopped. The operation check process of the present embodiment will be described with reference to the flowchart of FIG. 15 This process is performed when an operation check is performed after the vehicle system is started or before the vehicle system is stopped.

In S401, the control unit 50 determines whether the vehicle speed is 0, the brake is in an ON state, and the vehicle is in a stopped state. When it is determined that the vehicle is not in a stopped state (S401: NO), the process from S402 onward is skipped. When it is determined that the vehicle is stopped (S401: YES), the process proceeds to S402.

The control unit 50 confirms in S402 that the clutch 31 is engaged, and in S403 drives the clutch actuator 35 to disengage the clutch 31. In S404, the control unit 50 performs an abnormality diagnosis on the clutch 31 based on the detection value of the stroke sensor, the detection value of the current sensor of the clutch actuator 35, and the like. When the clutch 31 is a friction clutch, the detection value of a load sensor may be used instead of the stroke sensor. Here, the abnormality of the stroke sensor or the load sensor, the abnormality of the clutch actuator 35 abnormality, and clutch 31 sticking or disengagement abnormality are diagnosed. In the abnormality diagnosis, for example, the difference between the detection value and the target value is calculated, and when it is within the allowable range, it is determined to be normal, and when it is not within the allowable range, it is determined to be abnormal. The same applies to S408.

In S405, the control unit 50 determines whether or not the disengagement of the clutch 31 has been completed. When it is determined that the clutch 31 is not disengaged (S405: NO), the process returns to S403, and the release drive of the clutch actuator 35 continues. When it is determined that the clutch 31 has been disengaged (S405: YES), the process proceeds to S406.

The control unit 50 confirms in S406 that the MG rotation speed Nmg is 0, and in S407 drives the main motor 15 so that the MG rotation speed Nmg becomes the target rotation speed Nmg*. In S408, the control unit 50 performs an abnormality diagnosis of the main motor 15 based on the detection value of the rotation angle sensor and the detection value of the current sensor of the main motor 15, etc. Here, the main motor 15 is diagnosed for abnormalities in rotation speed and output.

In S409, the control unit 50 determines whether the MG rotation speed Nmg has reached the target rotation speed Nmg*. When it is determined that the MG rotation speed Nmg has not reached the target rotation speed Nmg* (S409: NO), the process returns to S407 and the main motor 15 continues to be driven. When it is determined that the MG rotation speed Nmg has reached the target rotation speed Nmg* (S409: YES), the process proceeds to S410.

In S410, the control unit 50 stops driving the main motor 15 and engages the clutch 31. In S411, the control unit 50 sets the driving mode to the standby mode. When an abnormality is detected in S404 or S408, the process shifts to fail-safe control.

In the present embodiment, the control unit 50 disengages the clutch 31 when the front wheels 11 are not rotating, and drives the main motor 15 to perform the abnormality diagnosis. By driving the main motor 15 with the clutch 31 in the disengaged state, it is possible to perform the abnormality diagnosis without moving the vehicle 99.

In the embodiment, the clutch 31 is provided in the front wheel drive unit 10, the front wheels 11 correspond to the “drive wheels”, the drive shaft 12 corresponds to the “drive shaft”, and the main motor 15 corresponds to the “drive source”.

### Other Embodiments

In the above embodiments, the clutch is provided in the front wheel drive unit. In other embodiments, the clutch may be provided in the rear wheel drive unit, or in the front and rear wheel drive units. When the clutch is provided in the rear wheel drive unit, the rear wheels 21 correspond to the “drive wheels”, the drive shaft 22 corresponds to the “drive shaft”, and the main engine motor 25 corresponds to the “drive source”. In addition, the main motor can be rotated even when the drive wheels are stopped by disengaging both the brake and clutch of a two-speed transmission mechanism, so application to the two-speed transmission mechanism is also possible.

In the above embodiments, the vehicle drive system is a so-called four-wheel drive system in which the main motor serving as the drive source is provided in the front wheel drive unit and the rear wheel drive unit. In another embodiment, the vehicle drive system may be a so-called two-wheel drive system in which the main motor is provided in either the front wheel drive unit or the rear wheel drive unit. Although the respective embodiments can be implemented in combination, the fourth embodiment is applied to a four-wheel drive system.

The control unit and the technique according to the present disclosure may be achieved by a dedicated computer provided by constituting a processor and a memory programmed to execute one or more functions embodied by a computer program. Alternatively, the control circuit described in the present disclosure and the method thereof may be realized by a dedicated computer configured as a processor with one or more dedicated hardware logic circuits. Alternatively, the control circuit and method described in the present disclosure may be realized by one or more dedicated computer, which is configured as a combination of a processor and a memory, which are programmed to perform one or more functions, and a processor which is configured with one or more hardware logic circuits. The computer programs may be stored, as instructions to be executed by a computer, in a tangible non-transitory computer-readable medium. The present disclosure is not limited to the embodiment described above but various modifications may be made within the scope of the present disclosure.

The present disclosure has been made in accordance with the embodiments. However, the present disclosure is not limited to such embodiments and configurations. The present disclosure also encompasses various modifications and variations within the scope of equivalents. Furthermore, various combination and formation, and other combination and formation including one, more than one or less than one element may be made in the present disclosure.

What is claimed is:

1. A vehicle control system for controlling a drive of a vehicle, comprising:
a drive source;
a clutch provided in a power transmission path from the drive source to a drive wheel and configured to switch between connecting and disconnecting a power transmission;
a clutch actuator configured to drive the clutch; and
a drive control unit configured to control a drive of the drive source and the clutch actuator;
wherein
at least one portion that meshes in an inclined manner with respect to a rotational direction is provided between the clutch and the drive wheel, and
the control unit switches the clutch from a disengaged state to an engaged state, and controls the clutch actuator so that a load greater than the load required for engaging the clutch is generated during input of a transient torque that inputs a driving force from the drive source,
the control unit, when an elimination of play on an output side is completed, reduces the load to place the clutch in an engaged and held state, and drives the drive source to generate torque.

2. The vehicle control system for controlling a drive of a vehicle according to claim 1, further comprising,
a power transmission unit configured to transmit a driving force of the drive source to the drive wheel, wherein
the power transmission unit has a reduction gear, and
the clutch is provided between the drive source and the reduction gear.

3. The vehicle control system for controlling a drive of a vehicle according to claim 2, wherein
the one portion is the reduction gear which meshes at an angle with respect to the direction of rotation.

4. The vehicle control system for controlling a drive of a vehicle according to claim 3, wherein
the reduction gear has a helical gear which meshes at an angle with respect to the direction of rotation.

5. A vehicle control system for controlling a drive of a vehicle, comprising:
a drive source;
a clutch provided in a power transmission path from the drive source to a drive wheel and configured to switch between connecting and disconnecting a power transmission;
a clutch actuator configured to drive the clutch; and
a drive control unit configured to control a drive of the drive source and the clutch actuator;
wherein
the control unit disengages the clutch when a torque fluctuation frequency of the drive source is in a resonance region of a drive shaft connected to the drive wheel.

6. The vehicle control system for controlling a drive of a vehicle according to claim 5, wherein
the drive source is provided separately for a front wheel drive unit and a rear wheel drive unit, and
when the torque fluctuation frequency of the drive source is in a resonance region, the drive is switched from a four-wheel drive mode to a two-wheel drive mode by disengaging the clutch.

7. The vehicle control system for controlling a drive of a vehicle according to claim 6, wherein
the drive source is controlled so that the torque lacking due to disengaging the clutch is output by the drive source on the drive wheel side when in two-wheel drive mode.

8. A vehicle control system for controlling a drive of a vehicle, comprising:
a drive source;
a clutch provided in a power transmission path from the drive source to a drive wheel and configured to switch between connecting and disconnecting a power transmission;
a clutch actuator configured to drive the clutch; and
a drive control unit configured to control a drive of the drive source and the clutch actuator;
wherein
the control unit determines whether the vehicle is passing over a step, and when it is determined that the vehicle passes over the step, disengages the clutch.

9. The vehicle control system for controlling a drive of a vehicle according to claim 8, wherein
the drive source is only motor, and when it is determined that the vehicle passes over a step, the control unit disengages the clutch and performs a rotation speed control of the motor.

10. The vehicle control system for controlling a drive of a vehicle according to claim 9, wherein
the control unit
disengages the clutch,
controls the rotation speed of the drive source to become a target rotation speed by the rotation speed control, and
when it is determined that a vehicle speed when the rotation speed of the drive source becomes the target rotation speed is greater than a vehicle speed determination threshold, performs a brake control.

11. A vehicle control system for controlling a drive of a vehicle, comprising:
a drive source;
a clutch provided in a power transmission path from the drive source to a drive wheel and configured to switch between connecting and disconnecting a power transmission;
a clutch actuator configured to drive the clutch; and
a drive control unit configured to control a drive of the drive source and the clutch actuator;
wherein
the control unit disengages the clutch when the drive wheel is not rotating, and drives the drive source to perform an abnormality diagnosis.

12. The vehicle control system for controlling a drive of a vehicle according to claim 11, wherein
the control unit
confirms that the clutch is engaged when the drive wheel is not rotating, disengages the clutch and performs an abnormality diagnosis on the clutch, and
when it is determined after the abnormality diagnosis on the clutch that a disengagement of the clutch is completed, drives the drive source and performs an abnormality diagnosis.
